(19) United States
(12) Patent Application Publication
(10) Pub. No.: US 2024/0097478 A1
(43) Pub. Date: Mar. 21, 2024

(54) POWER SUPPLY COMPRISED OF STANDARD ELECTRONIC COMPONENTS AND A BATTERY WITH A SLOPING DISCHARGE PROFILE

(71) Applicant: HHeli, LLC, Tulsa, OK (US)

(72) Inventor: Peter Bontorno, Tulsa, OK (US)

(21) Appl. No.: 18/370,751

(22) Filed: Sep. 20, 2023

Related U.S. Application Data
(60) Provisional application No. 63/408,157, filed on Sep. 20, 2022.
(60) Provisional application No. 63/408,160, filed on Sep. 20, 2022.
(60) Provisional application No. 63/408,163, filed on Sep. 20, 2022.
(60) Provisional application No. 63/408,166, filed on Sep. 20, 2022.

(51) Int. Cl. H02J 7/00

(52) U.S. Cl. CPC H02J 7/007182; H02J 7/0048; H02J 7/0069; H02J 2207/20

(57) ABSTRACT

A power supply, system, and method for adapting one or more batteries with an ever-declining monotonic discharge curve for use with a load that has an input voltage requirement that is not fully satisfied by the battery voltage. The power supply may have a boost or buck converter circuit or a combination of boost and buck converter circuits. The power supply may use a sensor node to toggle the converter or converters.

### CROSS-REFERENCE TO RELATED CASES

This application claims the benefit of U.S. provisional patent application Ser. No. 63/408,157, filed on Sep. 20, 2022, U.S. provisional patent application Ser. No. 63/408,160, filed on Sep. 20, 2022, U.S. provisional patent application Ser. No. 63/408,163, filed on Sep. 20, 2022, and U.S. provisional patent application Ser. No. 63/408,166, filed on Sep. 20, 2022, and incorporates such provisional applications by reference into this disclosure as is fully set out at this point.

### FIELD OF THE INVENTION

This disclosure relates to battery technology, more specifically, to a system and method for adapting one or more batteries with a sloping discharge profile for use with a load that has an input voltage requirement that is not fully satisfied by the battery voltage.

### BACKGROUND OF THE INVENTION

Some older battery chemistries, for example, those used in alkaline batteries, exhibit a discharge voltage slope profile that is substantially flat (approaching 0) during the beginning of its discharge, or at least relatively stable for a significant portion of the discharge, and very steep (approaching negative infinity) at the end of its discharge. These are often termed “plateaued” discharge curves. However, some newer battery chemistries exhibit an ever-declining monotonic discharge voltage profile that slopes downward throughout the discharge of the battery and does not exhibit the relative stability of plateaued curves. Linearity of such battery chemistries may differ throughout the state of charge of the battery, but, for many of these ever-declining monotonic battery chemistries, the steepest decline occurs near the fully charged state, with a shallower slope at the middle and end of the curve.

These newer battery chemistries may provide markedly higher capacities (greater than 1000 mAhr/g) and lower internal resistances versus older lithium-based batteries. However, they also present new challenges. Because the newer chemistries may decrease markedly in voltage as they are discharged, their voltages may drop below a useful level prematurely, while they have significant capacity remaining. Furthermore, toward the high end of the discharge curve, batteries of these chemistries may exceed optimal voltages for a desired load. For example, a low-voltage electronic device may require an operating input of less than 5 V, such as approximately 1.5 V.

What is needed is a power supply, system, and method for adapting one or more batteries with an ever-declining monotonic discharge profile for use with a load with an input voltage requirement that is not fully satisfied by the battery voltage.

### SUMMARY OF THE INVENTION

The invention of the present disclosure, in one aspect thereof, comprises a power supply for adapting a battery for use with a load that has an input voltage requirement that is not fully satisfied by the battery voltage. The power supply includes a battery, the battery having an ever-declining monotonic discharge curve, and at least one converter circuit, each converter circuit being either a boost converter circuit or a buck converter circuit. The battery may have an acidified metal oxide material in at least one of an anode and a cathode. The power supply may comprise a sensor node being configured to toggle the at least one converter circuit based on a measurement of a state of charge of the battery. The measurement of the state of charge of the battery may be calculated from a measured voltage of the battery. The power supply may also comprise an external power source configured to accomplish partial charge restoration on the battery.

The invention of the present disclosure, in another aspect thereof, comprises a system for adapting a battery with an ever-declining monotonic discharge curve for use with a load that has an input voltage requirement that is not fully satisfied by the battery voltage. The system includes a battery, the battery having an ever-declining monotonic discharge curve, and at least one converter circuit, each converter circuit being either a boost converter circuit or a buck converter circuit. The battery may have an acidified metal oxide material in at least one of an anode and a cathode. The system may comprise a sensor node being configured to toggle the at least one converter circuit based on a measurement of a state of charge of the battery. The measurement of the state of charge of the battery may be calculated from a measured voltage of the battery. The system may comprise an external power source configured to accomplish partial charge restoration on the battery.

The invention of the present disclosure, in another aspect thereof, comprises a method for adapting a battery for use with a load that has an input voltage requirement that is not fully satisfied by the battery voltage. The method includes the steps of providing a battery, the battery having an ever-declining monotonic discharge curve, and electrically connecting the battery to at least one converter circuit, each converter circuit being either a boost converter circuit or a buck converter circuit. The battery may have an acidified metal oxide material in at least one of an anode and a cathode. The method may comprise the step of electrically connecting a sensor node to the at least one converter circuit, the sensor node being configured to toggle the at least one converter circuit based on a measurement of a state of charge of the battery. The measurement of the state of charge of the battery may be calculated from a measured voltage of the battery. The method may comprise the step of electrically connecting an external power source configured to accomplish partial charge restoration on the battery.

### BRIEF DESCRIPTION OF THE DRAWINGS

FIG. 1 is a schematic diagram of an embodiment of a power supply configured to adapt a battery with an ever-declining monotonic discharge curve to a load with an input voltage requirement greater than the battery voltage.

FIG. 2 is a graph comparing a discharge curve of the power supply of FIG. 1 to a discharge curve of the battery of FIG. 1.

FIG. 3 is a schematic diagram of an embodiment of a power supply configured to adapt a battery with an ever-declining monotonic discharge curve to a load with an input voltage requirement less than the battery voltage.

FIG. 4 is a schematic diagram of an embodiment of a power supply configured to adapt a battery with an ever-declining monotonic discharge curve to a load with an input voltage requirement that may be greater than or less than the battery voltage.

FIG. 5 is a graph comparing a discharge curve of a specific embodiment of the power supply of FIG. 4 to a discharge curve of its battery.

FIG. 6 is a block diagram of an embodiment of a power supply configured to adapt a battery with an ever-declining monotonic discharge curve to a load with an input voltage requirement that may be greater than or less than the battery voltage, the power supply incorporating a charge controller and external power supply.

FIG. 7 is a graph comparing discharge curves of the power supply of FIG. 6 with and without the charge controller and external power supply and discharge curves of the battery of FIG. 6 with and without the charge controller and external power supply.

FIG. 8 is a table of experimentally determined attributes of an embodiment of an acidified metal oxide battery with an ever-declining monotonic discharge curve connected to a load.

### DETAILED DESCRIPTION OF THE PREFERRED EMBODIMENTS

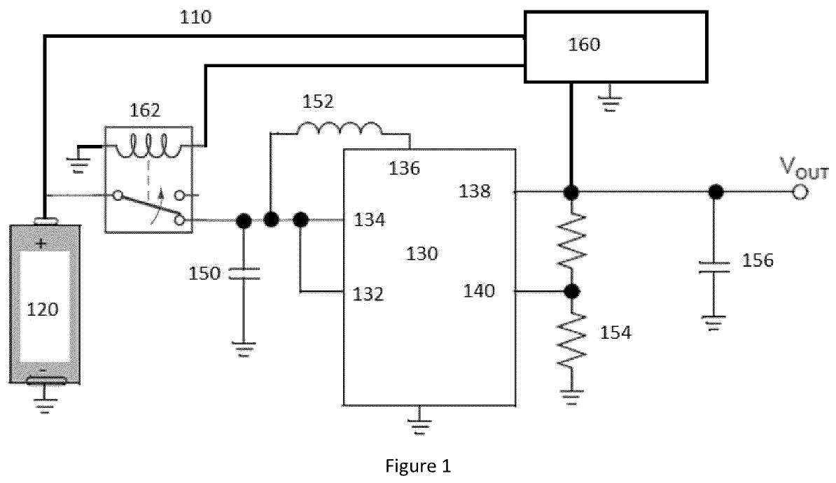

Referring now to FIG. 1, a schematic diagram of an embodiment of a power supply 110 configured to adapt a battery 120 with an ever-declining monotonic discharge curve to a load with an input voltage requirement greater than the battery 120 voltage is shown. One example of such a battery or cell having ever-declining monotonic discharge curve is one having electrodes or other components containing active materials as disclosed in U.S. Pat. No. 9,786,910, Johnson, et al., herein incorporated by reference. Such cells or batteries, which, when discharged continuously at a constant load, exhibit a nearly linear slope across the range of voltages from about 3 V (+/−1.5 V) to about 0 V (+0.5 V). More specifically, such a battery or battery cell, which may be utilized with embodiments of the present disclosure, comprises a battery electrode comprising at least one solid metal oxide nanomaterial including a surface that is acidic but not superacidic, the surface having a pH<5 when re-suspended, after drying, in water at 5 wt % and a Hammet function H0>−12. Stated another way, such battery or battery cell, which may be utilized with embodiments of the present disclosure, comprises a battery electrode solid metal oxide nanomaterial being in a form MₘOₓ/G, where Mₘ is a metal, Oₓ is total oxygen, MₘOₓ is a metal oxide, G is at least one electron withdrawing surface group, and “/” makes a distinction between the metal oxide and the electron-withdrawing surface group, the battery electrode solid metal oxide nanomaterial having a pH<5 when re-suspended, after drying, in water at 5 wt % and a Hammet function H0>−12, at least on its surface. Such materials are available from Ten-Nine Tech under the brand name TENIX.

In the present disclosure, the notion of utilizing a battery with a load having an input voltage requirement that is not fully satisfied by the battery voltage is discussed. It should be understood that such a condition includes cases where the battery voltage is too high, or too low, to meet the needs or demands of the load (which may be, for example, a circuit or motor requiring a specific voltage for satisfactory operation). The input voltage requirement may also be considered not fully satisfied where the battery meets the demands of the load's voltage requirements for only part of the discharge curve. For example, voltage may initially be too high for the load, followed by a period where the voltage from the battery is satisfactory, followed by a period when the voltage is too low (yet the battery or cell still contains sufficient energy to perform further electrical functions).

In some embodiments, the power supply 110 is connected to the battery 120 in a boost converter circuit. The boost converter circuit may be configured to provide an output voltage within a predetermined required load voltage range when the predetermined required load voltage range exceeds the voltage of the battery. The circuit may use a boost switching regulator 130 such as an MCP1640 boost converter chip. The boost switching regulator 130 may have an enable control input pin 132 electrically connected to an input voltage pin 134, an input-side capacitor 150, and a boost inductor input pin 136 through a boost inductor 152. The boost switching regulator 130 may also have an output voltage power pin 138 electrically connected to a voltage divider 154 and an output capacitor 156. The voltage divider 154 may be configured to provide feedback to the boost switching regulator 130 through a feedback voltage pin 140. If the battery 120 has a lower voltage than that required by a load at the power supply 110 output, then the power supply 110 may be configured to provide the required voltage relatively constant. For example, the power supply FIG. 1 can be configured to provide a steady output voltage of 3.3 V from a battery 120 with a voltage in the range of 0.9 V to 1.7 V.

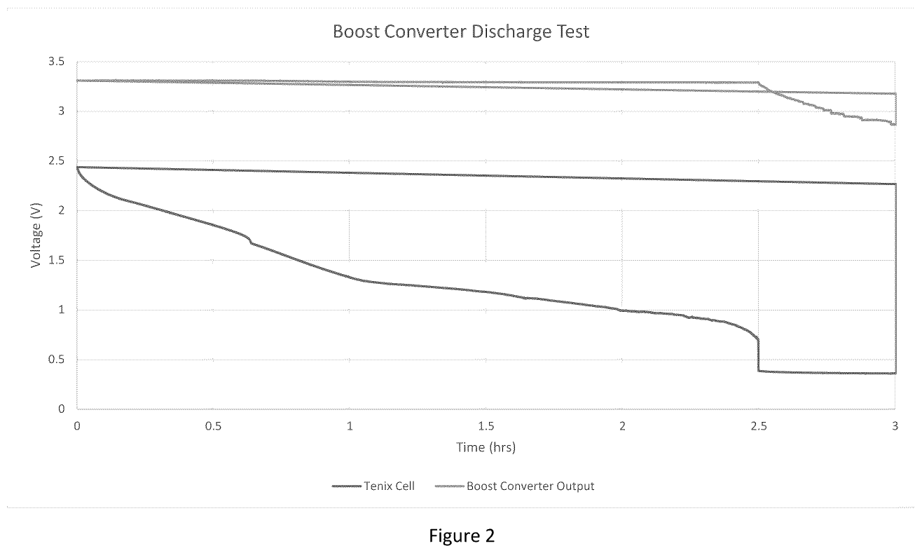

Referring now to FIG. 2, a graph comparing a discharge curve of the power supply 110 to a discharge curve of the battery 120 is shown. In some embodiments, the power supply 110 adapts the battery 120 to provide a voltage greater than the battery 120 voltage even when the battery 120 is charged to its maximum capacity. As the battery 120 discharges, its voltage may decrease along a downward-sloped curve until it exhausts its available charge. The power supply 110, however, may continue to supply a relatively steady voltage output despite the variability of the battery 120 voltage.

Still referring to FIGS. 1 and 2, in some embodiments, the power supply 110 may have a sensor node 160 with a processor or other controller for calculating a state of charge from the battery 120 voltage. For purposes of the present disclosure, a sensor node comprises a sensor and a silicon logic device. The silicon logic device may comprise a processor, controller, programmable logic device or another device capable of taking a reading from the associated sensor and implementing the control or method described herein. In some embodiments, the sensor and processor or other logic device may be on the same circuit board or die. Relays, resistors, connectors, ground connections, and the like that may be needed to interact with the rest of the circuitry are not shown, but will readily be properly placed as needed by one of ordinary skill in the art.

In some embodiments, the sensor node 160 may be in parallel with the boost switch regulator 130. The sensor node 160 may monitor instantaneous voltage of the power supply 110 or of the battery 120, rate of change, or output current. The sensor node 160 may perform mathematical calculations or other functions to achieve an accurate state of charge measurement. The sensor node 160 may be used to toggle (i.e., connect or disconnect) the boost switch regulator 130 using a relay or solid-state switch 162. The sensor node 160 may allow a load to be powered directly from the battery 120, bypassing the boost switch regulator 130. The sensor node 160 may determine the engagement of the boost switch regulator 130 based on specific load needs and efficient operation of the power supply 110.

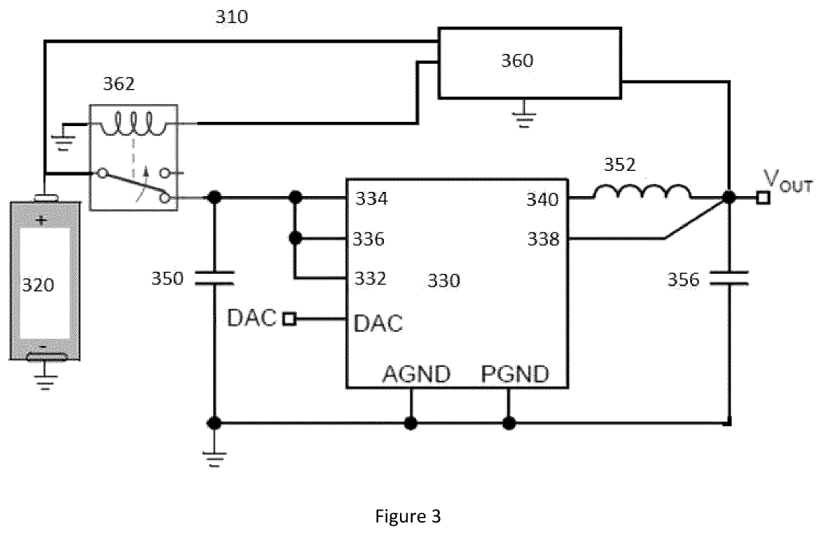

Referring now to FIG. 3, a schematic diagram of an embodiment of a power supply 310 configured to adapt a battery 320 with an ever-declining monotonic discharge curve to a load with an input voltage requirement less than the battery voltage is shown. In some embodiments, the power supply 310 is connected to a battery 320 in a conventional buck converter circuit. The buck converter circuit may be configured to provide an output voltage within a predetermined required load voltage range when the voltage of the battery exceeds the predetermined required load voltage range. The circuit may use a buck switching regulator 330 such as an MIC2224 buck converter chip. The buck switching regulator 330 may have an enable control input pin 332 electrically connected to an input voltage pin 334, a supply voltage pin 336, and an input-side capacitor 350. The buck switching regulator 330 may also have an output voltage power pin 338 electrically connected to a switch output pin 340 through a switch output inductor 352. The output voltage power pin 338 may be electrically connected to an output capacitor 356. The voltage provided at the output voltage power pin 338 may be regulated by a reference voltage provided to the buck switching regulator 330. If the battery 320 has a higher voltage than that required by a load at the output voltage power pin 338, then the power supply 310 may be configured to provide the required voltage relatively constant.

Still referring to FIG. 3, in some embodiments, the power supply 310 may have a sensor node 360 with a processor or other controller for calculating a state of charge from the battery 320 voltage. In some embodiments, the sensor node 360 may be in parallel with the buck switch regulator 330. The sensor node 360 may monitor instantaneous voltage of the power supply 310 or of the battery 320, rate of change, or output current. The sensor node 360 may perform mathematical calculations or other functions to achieve an accurate state of charge measurement. The sensor node 360 may be used to toggle (i.e., connect or disconnect) the buck switch regulator 330 using a relay or solid-state switch 362. The processor or other controller may allow a load to be powered directly from the battery 320, bypassing the buck switch regulator 330. The sensor node 360 may determine the engagement of the buck switch regulator 330 based on specific load needs and efficient operation of the power supply 310.

In embodiments where the battery 320 contains an acidified metal oxide material in either a cathode or an anode, the battery 320 may have its greatest efficiency over the second half of the battery's discharge. Higher efficiency at the end of discharge may be desirable because current draw may increase as the battery 320 voltage decreases. Losses may be minimized by maximizing the efficiency of the power supply 310 when the discharge current is near its peak.

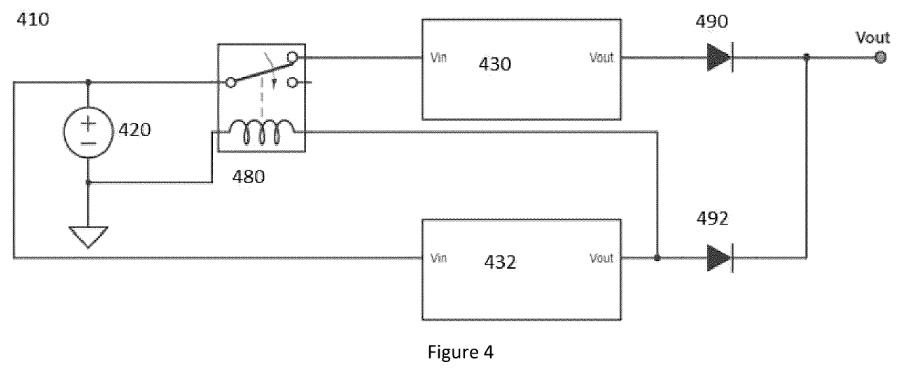

Referring now to FIG. 4, a block diagram of an embodiment of a power supply 410 configured to adapt a battery 420 with an ever-declining monotonic discharge curve to a load with an input voltage requirement that may be greater than or less than the battery voltage is shown. In some embodiments, the power supply 410 is connected to a battery 420 in a boost-buck circuit. The power supply 410 may include a boost converter 430 and a buck converter 432 electrically connected to the battery 420. The power supply 410 may also include a relay switch 480 configured to keep the battery 420 disconnected from the boost converter 430 until the battery's 420 voltage drops such that the buck converter 432 is no longer maintaining the power supply 410 output voltage. The power supply may include a boost converter diode 490 and a buck converter diode 492 to protect the power supply 410 at its voltage output.

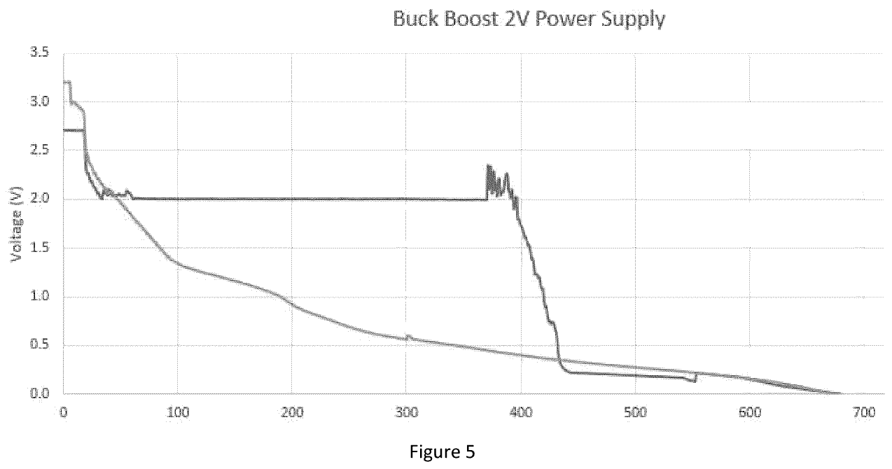

Referring now to FIG. 5, a graph comparing a discharge curve of a specific embodiment of the power supply 410 to a discharge curve of its battery 420 is shown. In this embodiment, the power supply 410 was constructed using an MCP1640B microchip in the boost converter 430 and an MIC2224 microchip in the buck converter 432. The buck converter 432 was configured to provide a voltage output of 2.7 V, and the boost converter 430 was configured to provide an output voltage of 2.0 V. The battery 420 was discharged through the power supply 410 to a fixed resistance load (not shown). At the beginning of the discharge, the battery 420 voltage was above 3.0 V, but the power supply 410 voltage was approximately 2.7 V. After the battery 410 voltage dropped to about 2.0 V, the power supply 410 voltage continued at about 2.0 V until the battery 410 voltage fell below a usable level.

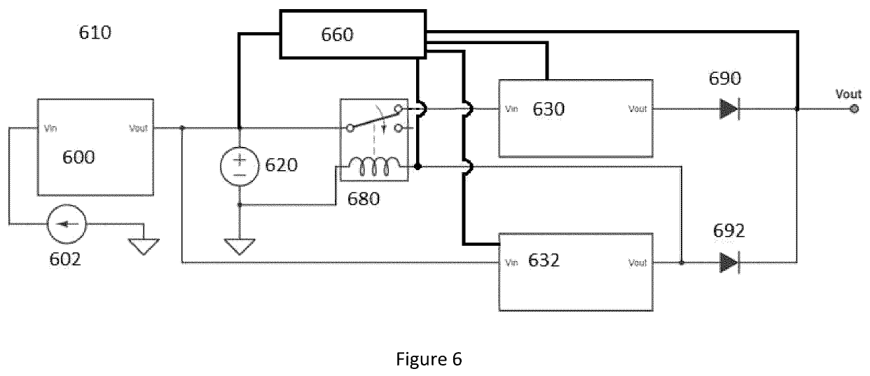

Referring now to FIG. 6, a block diagram of an embodiment of a power supply 610 configured to adapt a battery 620 with an ever-declining monotonic discharge curve to a load with an input voltage requirement that may be greater than or less than the battery voltage, the power supply incorporating a charge controller 600, is shown. In some embodiments, the power supply 610 is connected to a battery 620 in a boost-buck circuit, combining a boost converter circuit 630 and a buck converter circuit 632. The boost converter circuit 630 and the buck converter circuit 632 may be electrically connected to the battery 620. The power supply 610 may also include a relay switch 680 configured to keep the battery 620 disconnected from the boost converter 630 until the battery's 620 voltage drops such that the buck converter circuit 632 is no longer maintaining the power supply 610 output voltage. The power supply 610 may include a boost converter diode 690 and a buck converter diode 692 to protect the power supply 610 at its voltage output. If the battery 620 has an acidified metal oxide material in either its cathode or its anode, then the capacity of the power supply 610 may be extended using partial charge restoration throughout the discharge of the battery cells. Partial charge restoration is accomplished by briefly, periodically recharging the power supply 610 with an external power source 602, such as an energy harvester or other mechanism for providing electrical power. The external power source 602 may be connected in parallel to the battery 620 and configured to control trickle charging of the battery 620 from the external power source 602. In some embodiments, the power source and trickle charging may be insufficient to charge the battery 620 to full capacity.

In some embodiments, the power supply 610 may have a sensor node 660 which monitors instantaneous voltage, rate of change, or output current of the power supply 610 or of the battery 620. The sensor node 660 may perform mathematical calculations or other functions to achieve an accurate state of charge measurement. The sensor node 660 may toggle the boost converter 630 or buck converter 632 using the relay switch 680 or another mechanism, such as a solid-state switch. The sensor node 660 may allow a load to be powered directly from the battery 620, bypassing the buck and boost converters 630, 632. The sensor node 660 may determine the engagement of the buck and boost converters 630, 632 based on specific load needs and efficient operation of the power supply 610.

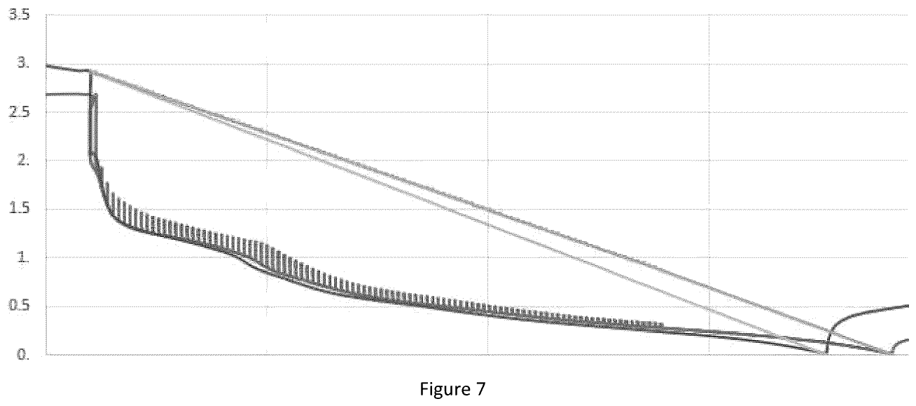

Referring now to FIG. 7, a graph comparing state-of-charge curves of the discharging power supply 610 with and without the charge controller 600 and state-of-charge curves of the discharging battery 620 with and without the charge controller is shown. In the specific embodiment represented in FIG. 7, the external power source 602 is electrically connected in parallel to the battery 620 such that the external power source 602 returned a low net current to the battery for approximately 30 seconds at intervals of approximately 15 minutes. The state of charge was plotted against time. The graph shows an ever-declining monotonic state-of-charge curve for the battery 620 without partial charge restoration, but, with the charge controller 600 and external power source 602, the state-of-charge curve shows periodic spikes representing a short-term effect of the partial charge restoration. The state-of-charge curves for the power supply 610 are nearly linear. With the charge controller 600 and external power source 602 performing the partial charge restoration, the total discharge of the power supply 610 was increased by about 10%.

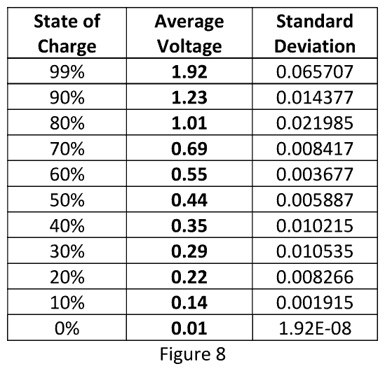

Referring now to FIG. 8, a table of experimentally determined attributes of an embodiment of a battery with an acidified metal oxide material in its cathode and with an ever-declining monotonic discharge curve connected to a load is shown. The voltage measurements to determine the state of charge may be taken with a background current draw of 1 mA or less to provide accurate values. A similar table can be generated for the no load condition or for other loading levels. The table represents an expected loading range for a specific device, but similar tables could be generated for any energy supply with an ever-declining monotonic discharge curve.

Despite the fact that embodiments of the power supply of the present disclosure may provide relatively steady voltage outputs, the state-of-charge for the power supply may be calculated from a table correlating battery voltages with state of charge and measurements taken across the battery. Additionally, a table correlating the battery's state of charge and its voltage, like that in FIG. 8, allows for a highly accurate state-of-charge estimation, compared with state-of-charge estimations of batteries with plateaued discharge curves, because the continual voltage decline throughout the discharge of the battery allows for the interpolation of a state of charge estimate without relying on impedance measurements. The state-of-charge estimation, in turn, may be used to control the boost or buck converters, depending on the embodiment used, needs of the load, and required efficiency of the system.

In some embodiments, a state of charge of a battery or power supply of this disclosure may be estimated using the equation,

$$S o C ( t ) = \frac{( {V}_{m e a s} - {V}_{L} )}{( {V}_{H} - {V}_{L} )} \times ( S o {C}_{H} - S o {C}_{L} ) + S o {C}_{L} ,$$

where SoC(t) is the state of charge of the battery at some time, t; Vₘₑₐₛ is the measured voltage of the battery at t; V_{L} is the highest voltage below Vₘₑₐₛ represented in the table; V_{H} is the lowest voltage above Vₘₑₐₛ represented in the table; SoC_{L} is the state of charge correlated with V_{L} in the table; and SoC_{H} is the state of charge correlated with V_{H} in the table. For example, for a power supply using the battery of FIG. 8, if the measured voltage of the battery, Vₘₑₐₛ, is 1.1 V, then V_{L} is 1.01 V, V_{H} is 1.23 V, and, therefore, SoC_{L} is 80%; and SoC_{H} is 90%. Calculating SoC(t) based on these numbers yields a value of 84.1%.

In some embodiments, a state of charge of a battery or power supply of this disclosure may be estimated using the equation,

$$S o C ( t ) = [ 1 - \frac{( {V}_{0} - {V}_{m e a s} )}{( {V}_{0} - {V}_{min} )} ] \times 100 \% ,$$

where SoC(t) is the state of charge of the battery at some time, t; Vₘₑₐₛ is the measured voltage of the battery at t; Vₘᵢₙ is the voltage at which the battery is no longer able to carry a load; and V₀ is the voltage of the battery in a fully charged state. For example, for a power supply using the battery of FIG. 8, if the measured voltage of the battery, Vₘₑₐₛ, is 1.1 V, then Vₘᵢₙ is 0.01 V, V₀ is 1.92 V. Calculating SoC(t) based on these numbers yields a value of 57.1%.

The power supply of the present disclosure is extremely versatile and admits of significant variations, such as the use of a multicell battery or substitution of a multi-battery pack for a battery. The power supply could operate using many electrical configurations, physical layouts, and specific electrical components. The output voltage of the power supply could be used with various voltage shaping devices and techniques, or the absence thereof, according to the needs of various loads and applications. Furthermore, there are many options for an external power source and corresponding methods for creating a charge restoration current. The power supply may be used with many kinds of loads or without a load. Finally, the state of charge of the power supply or battery could be measured, calculated, displayed, and otherwise used in many ways, and those measurements and calculations may be displayed in many ways. While the specific embodiments of this disclosure are designed especially for low-power electronic applications, the system and method disclosed here could easily be extrapolated for use in high power devices, battery modules, and battery packs.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

It should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

It should also be understood that the diagrams and drawings of the present disclosure may not exhibit every component that might be present in a physical system. However, any such components are well known such that one of ordinary skill in the art could make and use systems of the present disclosure without undue experimentation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A power supply for adapting a battery for use with a load that has an input voltage requirement that is not fully satisfied by the battery voltage, the power supply comprising:
a battery, the battery having an ever-declining monotonic discharge curve; and
at least one converter circuit, each converter circuit being either a boost converter circuit or a buck converter circuit.

2. The power supply of claim 1, wherein the battery has an acidified metal oxide material in at least one of an anode and a cathode.

3. The power supply of claim 1, further comprising a sensor node being configured to toggle the at least one converter circuit based on a measurement of a state of charge of the battery.

4. The power supply of claim 3, wherein the measurement of the state of charge of the battery is calculated from a measured voltage of the battery.

5. The power supply of claim 1, further comprising an external power source configured to accomplish partial charge restoration on the battery.

6. A system for adapting a battery with an ever-declining monotonic discharge curve for use with a load that has an input voltage requirement that is not fully satisfied by the battery voltage, the system comprising:
at least one converter circuit, each converter circuit being either a boost converter circuit or a buck converter circuit.

7. The system of claim 6, further comprising the battery with an ever-declining monotonic discharge curve, wherein the battery has an acidified metal oxide material in at least one of an anode and a cathode.

8. The system of claim 7, further comprising a sensor node being configured to toggle the at least one converter circuit based on a measurement of a state of charge of the battery.

9. The system of claim 8, wherein the measurement of the state of charge of the battery is calculated from a measured voltage of the battery.

10. The system of claim 7, further comprising an external power source configured to accomplish partial charge restoration on the battery.

11. A method for adapting a battery for use with a load that has an input voltage requirement that is not fully satisfied by the battery voltage, the method comprising the steps of:
providing a battery, the battery having an ever-declining monotonic discharge curve; and
electrically connecting the battery to at least one converter circuit, each converter circuit being either a boost converter circuit or a buck converter circuit.

12. The method of claim 11, wherein the battery has an acidified metal oxide material in at least one of an anode and a cathode.

13. The method of claim 12, the method further comprising the step of electrically connecting a sensor node to the at least one converter circuit, the sensor node being configured to toggle the at least one converter circuit based on a measurement of a state of charge of the battery.

14. The method of claim 13, wherein the measurement of the state of charge of the battery is calculated from a measured voltage of the battery.

15. The method of claim 14, the method further comprising the step of electrically connecting an external power source configured to accomplish partial charge restoration on the battery.
